(19) United States
(12) Patent Application Publication
(10) Pub. No.: US 2025/0059634 A1
(43) Pub. Date: Feb. 20, 2025

(54) GREY CAST IRON, IN PARTICULAR FOR DISC BRAKE COMPONENTS

(71) Applicant: Brembo S.p.A., Curno, Bergamo (IT)

(72) Inventors: Bozena DUDZIK, Curno, Bergamo (IT); Mateusz WOJCIECHOWSKI, Curno, Bergamo (IT); Fabiano CARMINATI, Curno, Bergamo (IT)

(21) Appl. No.: 18/724,220

(22) PCT Filed: Dec. 23, 2022
(86) PCT No.: PCT/IB2022/062732

§ 371 Date: Jun. 26, 2024

(30) Foreign Application Priority Data
Dec. 28, 2021 (IT) 102021000032792

(51) Int. Cl. C22C 37/10; C21D 5/00; C22C 37/08; F16D 65/12

(52) U.S. Cl. CPC C22C 37/10; C21D 5/00; C22C 37/08; F16D 65/125; C21D 2211/003; C21D 2211/005; C21D 2211/009; F16D 2200/0013

(57) ABSTRACT

A grey cast iron may have within a ferrous matrix: an amount of carbon between 3.60 and 3.90% by weight; an amount of silicon between 1.40 and 1.90% by weight; an amount of titanium not higher than 0.10% by weight; an amount of boron between 0.04 and 0.07% by weight; an amount of vanadium between 0.07 and 0.14% by weight; an amount of manganese between 0.60% and 0.90% by weight; an amount of nickel not higher than 0.20% by weight; an amount of chromium not higher than 0.35% by weight; an amount of copper not higher than 0.35% by weight; an amount of phosphorus not higher than 0.10% by weight; an amount of sulphur not higher than 0.12% by weight; an amount of tin not higher than 0.10% by weight; an amount of molybdenum not higher than 0.10% by weight.

### FIELD OF THE INVENTION

The present invention relates to cast iron, in particular for manufacturing a disc for disc brakes, and to a disc made from said cast iron.

### BACKGROUND ART

Discs for disc brakes made of grey cast iron are particularly subject to wear phenomena at the braking bands. In addition to inevitably affecting the durability of the discs, such wear phenomena contribute to the PM10 particulate matter emission into the atmosphere, with negative consequences for the environment and human health.

Indeed, as brake discs wear out, they release micrometre-sized metal particles into the environment, generated by the discs rubbing against the pads. Some of these particles adhere to the rim of the wheel, while others fall to the ground or become airborne. Brake wear particles thus form a non-negligible source of air pollution.

Therefore, the need is strongly felt in the automotive industry for brake discs made of grey cast iron and provided with high wear resistance, in particular for high-performance vehicles and extreme braking applications, such as high-end cars or racing motorcycles.

Indeed, increased wear resistance would lead to an increase in the service life of the brake discs as well as a reduction in the emission of metal dust into the environment.

Brake discs are subject to high mechanical and thermal stresses, which result in reaching high temperatures on the braking bands which can lead to declines in braking performance if not even to the formation of cracks on said braking bands.

Furthermore, brake discs are subject to corrosion phenomena. The need for brake discs made of grey cast iron to also exhibit high corrosion resistance which increases the service life thereof is thus particularly felt. Therefore, the increase in wear resistance should not adversely affect the corrosion resistance.

Therefore, the problem underlying the present invention is to provide a grey cast iron which is capable of exhibiting high wear resistance without adversely affecting the mechanical strength and corrosion resistance.

### SUMMARY OF THE INVENTION

The problem outlined above is solved by a grey cast iron as well as a disc for disc brakes, as outlined in the appended claims, the definitions of which form an integral part of the present description.

The grey cast iron of the present invention advantageously exhibits higher wear resistance, which in turn allows a drastic reduction in PM10 particulate matter emissions into the atmosphere with consequent benefits for the environment and human health.

Further features and advantages of the invention will become apparent from the description of some embodiments, given below by way of non-limiting indication.

### DETAILED DESCRIPTION OF THE INVENTION

A grey cast iron comprising carbon, silicon, titanium, boron, vanadium, manganese, nickel, chromium, copper, phosphorus, sulphur, tin, and molybdenum, within a ferrous matrix, is the subject of the present invention. These alloying elements are contained in the grey cast iron according to the invention in the following percentage amounts by weight, where said percentage values are with respect to the total weight of the cast iron:
carbon in an amount between 3.60 and 3.90% by weight;
silicon in an amount between 1.40 and 1.90% by weight;
titanium in an amount not higher than 0.10% by weight;
boron in an amount between 0.04 and 0.07% by weight;
vanadium in an amount between 0.07 and 0.14% by weight;
manganese in an amount between 0.60% and 0.90% by weight;
nickel in an amount not higher than 0.20% by weight;
chromium in an amount not higher than 0.35% by weight;
copper in an amount not higher than 0.35% by weight;
phosphorus in an amount not higher than 0.10% by weight;
sulphur in an amount not higher than 0.12% by weight;
tin in an amount not higher than 0.10% by weight;
molybdenum in an amount not higher than 0.10% by weight.

Optionally, said grey iron can comprise tungsten, for example in an amount not higher than 0.15% by weight or not higher than 0.12% by weight. In a specific embodiment, said cast iron comprises tungsten in an amount not higher than 0.02% by weight, for example not higher than 0.012% by weight.

In the aforesaid grey cast iron, carbon is in the form of graphite.

Preferably, the amount of carbon is between 3.65 and 3.85% by weight, more preferably between 3.70 and 3.80% by weight, even more preferably between 3.75 and 3.80% by weight.

Preferably, the amount of silicon is between 1.50 and 1.80% by weight, more preferably between 1.50 and 1.70% by weight, even more preferably between 1.60 and 1.65% by weight.

Preferably, the amount of titanium is not higher than 0.08% by weight, more preferably is between 0.01 and 0.05% by weight, even more preferably is between 0.01 and 0.03% by weight.

Preferably, the amount of boron is between 0.04 and 0.06% by weight, more preferably is between 0.04 and 0.05% by weight.

Preferably, the amount of vanadium is between 0.08 and 0.12% by weight, more preferably is between 0.09 and 0.11% by weight.

Preferably, the amount of manganese is between 0.60 and 0.80% by weight, more preferably is between 0.60 and 0.70% by weight, even more preferably is between 0.65 and 0.70% by weight.

Preferably, the amount of nickel is not higher than 0.10% by weight, for example is not higher than 0.08% by weight, 0.05% by weight, 0.04% by weight.

Preferably, the amount of chromium between 0.10 and 0.30% by weight, for example between 0.10 and 0.20% by weight.

Preferably, the amount of copper is not higher than 0.30% by weight, more preferably is between 0.10 and 0.30% by weight.

Preferably, the amount of phosphorus is not higher than 0.08% by weight, more preferably is between 0.02 and 0.07% by weight, even more preferably is between 0.03 and 0.05% by weight.

Preferably, the amount of sulphur is not higher than 0.10% by weight, more preferably is between 0.05 and 0.09% by weight, even more preferably is between 0.07 and 0.08% by weight.

Preferably, the amount of tin is not higher than 0.08% by weight, more preferably is between 0.02 and 0.07% by weight, even more preferably is between 0.02 and 0.05% by weight.

Preferably, the amount of molybdenum is not higher than 0.08% by weight, more preferably is between 0.02 and 0.07% by weight, even more preferably is between 0.03 and 0.05% by weight.

Preferably, said grey cast iron either consists of or essentially consists of the aforesaid alloying elements and said ferrous matrix, i.e., the remaining amount by weight of grey cast iron, with respect to the amounts of the alloying elements as defined above, either consists of or essentially consists of said ferrous matrix. The phrase “essentially consists of” denotes that the grey cast iron of the invention, in addition to the aforesaid alloying elements and ferrous matrix, can comprise impurities, such as niobium and/or aluminium, each in an amount lower than 0.01% by weight; preferably, the grey cast iron of the invention contains impurities in an overall amount lower than 0.01% by weight.

According to an embodiment of the invention, said grey cast iron has the following composition:
3.77% by weight of carbon;
1.65% by weight of silicon;
0.0103% by weight of titanium;
0.0437% by weight of boron;
0.101% by weight of vanadium;
0.673% by weight of manganese;
0.0366% by weight of nickel;
0.198% by weight of chromium;
0.207% by weight of copper;
0.0363% by weight of phosphorus;
0.0769% by weight of sulphur;
0.024% by weight of tin;
0.0317% by weight of molybdenum;
0.012% by weight of tungsten,
   the remaining amount by weight essentially consisting of the ferrous matrix.

Preferably, the grey cast iron of the invention is of the fine lamellar type, and the carbon contained therein is mainly in the form of lamellar graphite. Preferably, said grey cast iron comprises fine lamellae of graphite belonging to the category indicated by the Roman numeral “I”. Preferably, the graphite lamellae have dimensions indicated by reference numerals from 3 to 8, preferably from 3 to 5. The shape and size of the above graphite are as classified in standard UNI EN ISO 945-1.

Preferably, the ferrous matrix of grey cast iron is of the pearlitic type.

Preferably, said grey cast iron comprises pearlite in an amount not lower than 95% by weight with respect to the weight of the ferrous matrix. Preferably, said grey cast iron comprises pearlite in an amount higher than 95% by weight, or higher than 96% by weight, or higher than 97% by weight, or higher than 98% by weight, or higher than 99% by weight, with respect to the weight of the ferrous matrix.

Preferably, said grey cast iron comprises ferrite in an amount not higher than 5% by weight with respect to the weight of the ferrous matrix. According to various embodiments, said grey cast iron comprises ferrite in an amount lower than 5% by weight, or lower than 4% by weight, or lower than 3% by weight, or lower than 2% by weight, or lower than 1% by weight, with respect to the weight of the ferrous matrix. According to a preferred embodiment, said grey cast iron comprises ferrite in an amount of about 1% by weight with respect to the weight of the ferrous matrix. According to another preferred embodiment, said grey cast iron does not comprise ferrite.

Preferably, said grey cast iron comprises cementite and free carbides in an amount not higher than 5% by weight with respect to the weight of the ferrous matrix. According to various embodiments, said grey cast iron comprises cementite and free carbides in an amount lower than 5% by weight, or lower than 4% by weight, or lower than 3% by weight, or lower than 2% by weight, or lower than 1% by weight, with respect to the weight of the ferrous matrix. According to a preferred embodiment, said grey cast iron comprises cementite and free carbides in an amount not higher than 1% by weight, or lower than 1% by weight, with respect to the weight of the ferrous matrix.

Advantageously, the grey cast iron of the present invention can be used for the production of disc brake components. Advantageously, the grey cast iron of the present invention can be used to produce at least one braking band of a disc for disc brakes of any type.

### Experimental Tests

Experimental wear tests were conducted, comparing a brake disc made from a grey cast iron according to the present invention (Example 1) and a brake disc made from a grey cast iron not covered by the present invention (Comparison Example).

### COMPARISON EXAMPLE

A brake disc was made from a grey cast iron having the following composition: 3.74% by weight of carbon; 1.65% by weight of silicon; 0.55% by weight of manganese; 0.1% by weight of nickel; 0.15% by weight of chromium; 0.1% by weight of molybdenum; 0.2% by weight of copper; <0.1% by weight of sulphur; <0.08% by weight of phosphorus; 0.023% by weight of tin; <0.09% by weight of titanium; the remaining part by weight consisting of a ferrous matrix. Said ferrous matrix consists of 1% by weight of ferrite, 98.5% by weight of pearlite, and 0.5% by weight of carbides.

The brake disc made from said grey cast iron is hereinafter referred to as “Comparison Disc”.

### Example 1

A brake disc was manufactured, identical to the Comparison Disc, but using a grey cast iron according to the invention, having the following composition: 3.77% by weight of carbon; 1.65% by weight of silicon; 0.0103% by weight of titanium; 0.0437% by weight of boron; 0.101% by weight of vanadium; 0.673% by weight of manganese; 0.0366% by weight of nickel; 0.198% by weight of chromium; 0.207% by weight of copper; 0.0363% by weight of phosphorus; 0.0769% by weight of sulphur; 0.024% by weight of tin; 0.0317% by weight of molybdenum; 0.012% by weight of tungsten; the remaining part by weight essentially consisting of a ferrous matrix.

The ferrous matrix consists of 95.96% by weight of pearlite and 4.04% by weight of carbides. Graphite lamellae belong to the category “I” defined above, and have dimensions indicated by reference numerals from 3 to 5, as defined above.

The brake disc made from such a grey cast iron is hereinafter referred to as “Disc 1”.

### Experimental Tests

The “Comparison Disc” and “Disc 1” according to the invention were subjected to multiple repetitions of the WLTP test for detecting PM10 emission (1-hour conditioning with air at 20° C. and 50% relative humidity+303 stops (about 7.5 hours of testing)+cooling). The parameters used are as follows:
Average brake speed: 43.7 km/h;
Deceleration: 0.49-2.18 m/s²;
Average deceleration: 0.97 m/s²;
BT (“Braking Temperature”): from <40° C. up to 175° C.;
Stop number: 303;
Total distance: 192 km.

At the end of such a test, the mass loss of the two discs (“Disc Mass Loss”) was measured and the following results were obtained:
“Comparison Disc”: 9.0 gram mass loss,
“Disc 1”: 7.8 gram mass loss.

It results that, with the conditions being equal, “Disc 1” underwent a lower mass loss than that experienced by the “Comparison Disc”.

Furthermore, PM10 emission factors [mg km⁻¹wheel⁻¹] for the two discs were also derived, in particular:
“Comparison Disc”: PM10 emission factor (PM10 EF) of 1.92 mg km⁻¹wheel⁻¹,
“Disc 1”: PM10 emission factor (PM10 EF) of 0.77 mg km⁻¹wheel⁻¹.

It results that the PM10 emission factor is significantly lower for “Disc 1” than for the “Comparison Disc”.

From the above results, it is apparent that the grey cast iron according to the invention advantageously exhibits higher wear resistance than the standard grey cast iron taken as a reference, thus allowing a drastic reduction in PM10 particulate matter emissions into the atmosphere.

“Disc 1” and the “Comparison Disc” were further characterized from a mechanical point of view and considering the functional parameters. The results are shown in Table 1:

TABLE 1

| | Comparison Disc | Disc 1 |
|---|---|---|
| Tensile strength Rm [MPa] | 190 | 215 |
| Hardness [HB] | 180-186 | 224 |
| Young's module [GPa] | ND | 119 |
| Corrosion [% mass loss] | 0.29 | 0.23 |

From a comparison of the data shown in Table 1 it emerges that the performance in terms of mechanical strength and corrosion resistance of “Disc 1” is substantially comparable to that of the “Comparison Disc”.

As can be appreciated from the description above, the grey cast iron of the present invention allows overcoming the drawbacks of the prior art.

In particular, the cast iron according to the present invention and corresponding brake discs made from said cast iron offers higher wear resistance, and significantly lower PM10 particulate matter emissions into the atmosphere, compared to the standard grey cast iron taken as a reference, this without resulting in a decay of mechanical strength and corrosion resistance.

It is apparent that only one particular embodiment of the present invention was described. Person skilled in the art will be able to make to the cast iron and the brake disc all the modifications required to adapt them to particular conditions, without departing from the scope of protection as defined in the appended claims.

1-30. (canceled)

31. Grey cast iron comprising carbon, silicon, titanium, boron, vanadium, manganese, nickel, chromium, copper, phosphorus, sulphur, tin and molybdenum within a ferrous matrix, wherein:
the amount of carbon is comprised between 3.60 and 3.90% by weight;
the amount of silicon is comprised between 1.40 and 1.90% by weight;
the amount of titanium is not higher than 0.10% by weight;
the amount of boron is comprised between 0.04 and 0.07% by weight;
the amount of vanadium is comprised between 0.07 and 0.14% by weight;
the amount of manganese is comprised between 0.60% and 0.90% by weight;
the amount of nickel is not higher than 0.20% by weight;
the amount of chromium is not higher than 0.35% by weight;
the amount of copper is not higher than 0.35% by weight;
the amount of phosphorus is not higher than 0.10% by weight;
the amount of sulphur is not higher than 0.12% by weight;
the amount of tin is not higher than 0.10% by weight;
the amount of molybdenum is not higher than 0.10% by weight.

32. The cast iron according to claim 31, further comprising tungsten in an amount not higher than 0.15% by weight.

33. The cast iron according to claim 31, wherein the amount of carbon is comprised between 3.65 and 3.85% by weight.

34. The cast iron according to claim 31, wherein the amount of silicon is comprised between 1.50 and 1.80% by weight.

35. The cast iron according to claim 31, wherein the amount of titanium is not higher than 0.08% by weight.

36. The cast iron according to claim 31, wherein the amount of boron is comprised between 0.04 and 0.06% by weight.

37. The cast iron according to claim 31, wherein the amount of vanadium is comprised between 0.08 and 0.12% by weight.

38. The cast iron according to claim 31, wherein the amount of manganese is comprised between 0.60 and 0.80% by weight.

39. The cast iron according to claim 31, wherein the amount of nickel is not higher than 0.10% by weight.

40. The cast iron according to claim 31, wherein the amount of chromium is comprised between 0.10 and 0.30% by weight.

41. The cast iron according to claim 31, wherein the amount of copper is not higher than 0.30% by weight.

42. The cast iron according to claim 31, wherein the amount of phosphorus is not higher than 0.08% by weight.

43. The cast iron according to claim 31, wherein the amount of sulphur is not higher than 0.10% by weight.

44. The cast iron according to claim 31, wherein the amount of tin is not higher than 0.08% by weight.

45. The cast iron according to claim 31, wherein the amount of molybdenum is not higher than 0.08% by weight.

46. The cast iron according to claim 31, wherein the remaining amount by weight essentially consists of the ferrous matrix.

47. The cast iron according to claim 31, said grey cast iron being of the fine lamellar-type.

48. The cast iron according to claim 31, wherein the ferrous matrix of said grey cast iron is of the pearlitic-type.

49. The cast iron according to claim 31, comprising ferrite in an amount lower than 5% by weight with respect to the weight of the ferrous matrix.

50. The cast iron according to claim 31, comprising cementite and free carbides in an amount not higher than 5% by weight with respect to the weight of the ferrous matrix.

51. Disc for disc brakes, comprising a braking band made of a grey cast iron according to claim 331.

52. The cast iron according to claim 32, comprising tungsten in an amount not higher than 0.012% by weight.

53. The cast iron according to claim 33, wherein the amount of carbon is comprised between 3.70 and 3.80% by weight.

54. The cast iron according to claim 34, wherein the amount of silicon is comprised between 1.50 and 1.70% by weight.

55. The cast iron according to claim 35, wherein the amount of titanium is comprised between 0.01 and 0.05% by weight.

56. The cast iron according to claim 36, wherein the amount of boron is comprised between 0.04 and 0.05% by weight.

57. The cast iron according to claim 38, wherein the amount of manganese is comprised between 0.60 and 0.70% by weight.

58. The cast iron according to claim 41, wherein the amount of copper is comprised between 0.10 and 0.30% by weight.

59. The cast iron according to claim 47, said grey cast iron including fine lamellae of graphite belonging to the category indicated with the Roman numeral “I” according to the standard UNI EN ISO 945-1.

60. The cast iron according to claim 48, wherein the percentage by weight of pearlite is not lower than 95% with respect to the weight of the ferrous matrix.
